(19) United States
(12) Patent Application Publication
(10) Pub. No.: US 2012/0145200 A1
(43) Pub. Date: Jun. 14, 2012

(54) DISHWASHER HAVING A CLEANING SOLUTION RESERVOIR AND ASSOCIATED METHOD

(75) Inventors: Helmut Jerg, Giengen (DE); Michael Georg Rosenbauer, Reimlingen (DE)

(73) Assignee: BSH BOSCH UND SIEMENS HAUSGERÄTE GMBH, Munich (DE)

(21) Appl. No.: 13/391,294

(22) PCT Filed: Aug. 23, 2010
(86) PCT No.: PCT/EP2010/062242

§ 371 Date: Feb. 20, 2012

(30) Foreign Application Priority Data
Sep. 3, 2009 (DE) 10 2009 029 186.5

(51) Int. Cl. A47L 15/02; B08B 3/04; A47L 15/42

(52) U.S. Cl. 134/25.2; 134/94.1

(57) ABSTRACT

A dishwasher includes a liquid system having a washing solution reservoir for making available washing solution for a washing cycle of a subsequent dishwashing program. Via a hot water inlet via of an external hot water supply hot water can be introduced into the liquid system for forming the washing solution and filling the washing solution reservoir with washing solution.

The present invention relates to a dishwasher, especially a domestic dishwasher, the liquid system of which has a washing solution reservoir for making available washing solution for the washing cycle of a subsequent dishwashing program.

A dishwasher is known from experience in which, before a washing cycle for washing dishes is carried out, in which the dishes are treated with washing solution in a washing chamber, there is the option of carrying out a pre-heating cycle to pre-heat the washing solution. This operating function is referred to as a “Wait & Run” function. If this option is chosen then pre-heated washing solution is available at the start of the washing cycle, so at least one heating phase can be shortened or even suppressed during at least one liquid-conveying partial washing cycle of the washing cycle. The time required for a washing cycle can be reduced as a result.

One drawback of the known dishwasher, however, is that the electrical energy requirement of the dishwasher can be too great when the pre-heating option is performed.

The object of the present invention is to provide a dishwasher with a pre-heating option in which the energy efficiency is improved.

The object is achieved in a dishwasher of the type mentioned in the preamble in that in order to fill the washing solution reservoir with washing solution, hot water can be obtained from an external hot water supply via a hot water inlet and can be introduced into the liquid system.

As a result of the fact that in order to fill the washing solution reservoir, hot water can be obtained from an external hot water supply via a hot water inlet and can be introduced into the liquid system of the dishwasher, heating energy may be reduced at the appliance end, because in a dishwashing program which is started subsequently this hot water from the washing solution reservoir can be used for a partial washing cycle, such as a washing cycle or a rinsing cycle, which requires heated water. If the temperature of the hot water from the washing solution reservoir is sufficiently high a heating phase can be partially or completely omitted in this partial washing cycle. In particular, the pre-wash cycle of a washing cycle implemented or induced by a selected dishwashing program may be dispensed with or omitted. The duration of dishwashing programs may be reduced in this way and this obtaining of hot water can be energy efficient in particular for a “wait & run”.

According to an advantageous development of the invention the hot water can be introduced into the washing solution reservoir without re-heating if its intake temperature is equal to or greater than a minimum temperature. This allows a maximum energy reduction.

If the intake temperature of the hot water obtained is less than the minimum temperature it may be expedient to heat the hot water before it is introduced into the washing solution reservoir, or to heat the hot water introduced into the washing solution reservoir by re-heating to at least the desired minimum temperature. This may be carried out with low expenditure of energy at the appliance end.

The hot water inlet for admitting hot water from the external hot water supply can expediently be controlled by a controller. The incoming volume of water can be metered as a result.

Within the scope of the invention a washing solution reservoir is in particular taken to mean a reservoir which is used for temporarily storing washing liquor. It is expediently arranged outside of the dishwasher's washing tank.

The liquid system of the inventive dishwasher can in particular include a circulating pump, a sump in the bottom of the dishwasher's washing tank, an electric heater, one or more spray mechanism(s), one or more fluid line(s) and/or the washing solution reservoir.

According to an expedient development of the invention a cold water inlet for admitting cold water from an external cold water supply and which can be controlled by a controller may also be provided in addition to the hot water connection. Hot water and/or cold water can consequently be specifically supplied into the liquid system of the inventive dishwasher for each program step of a selected dishwashing program or for each partial washing cycle associated therewith, whereby an increase in efficiency, in particular with respect to the drying performance and/or cleaning performance of the inventive dishwasher may be achieved.

In particular it may be expedient if a controller is provided with which at least one washing program for controlling a washing cycle for washing dishes in a washing chamber and at least one preceding pre-heating program for controlling a pre-heating cycle for the washing solution temporarily stored in the washing solution reservoir can be called up, and in particular separately from each other in each case. Filling the washing solution reservoir with sufficiently hot washing solution may be controlled and monitored thereby. In particular this pre-heating program can include the drawing of hot water from the external hot water supply. It is therefore particularly possible for the pre-heating cycle to be limited to a pump phase during which the hot water can be pumped into the washing solution reservoir. A re-heating phase for the drawn hot water can therefore be omitted if its intake temperature is equal to or greater than a desired minimum temperature. If the intake temperature of the drawn hot water is less than the desired minimum temperature the pre-heating cycle can in particular include a re-heating phase during which the hot water can be re-heated.

Overall energy can therefore be saved at the appliance end compared with a dishwasher which is connected solely to a cold water supply.

An expedient development of the invention relates to a dishwasher, especially a domestic dishwasher, having a controller in which at least one washing program for controlling a washing cycle for washing dishes in a washing chamber and at least one pre-heating program for controlling a pre-heating cycle, which provides a heating phase for pre-heating a washing solution for a washing cycle, can be called up separately from each other in each case. In particular it comprises a hot water inlet which can be controlled by the controller and which is provided for admitting hot water for connection to an external hot water supply, hot water being admitted during the pre-heating cycle by means of the hot water inlet and the washing solution provided for pre-heating being formed using the admitted hot water. “Wait & run” operation of the dishwasher in particular can be provided in an energy efficient manner as a result.

The dishwasher therefore in particular comprises a controller for automatically controlling operating procedures of the dishwasher. The controller can be designed as what is known as a sequential controller, and in particular as an electronic sequential controller, for this purpose.

At least one washing program for controlling a washing cycle for washing dishes, in particular for washing tableware, is stored in the controller. A plurality of washing programs is advantageously provided, of which one in each case can be selected and started by the user. It is consequently possible to adjust the process of a washing cycle in particular to the size of the load, the type of load, the degree of soiling of the dishes and/or the desired length of the washing cycle.

The respectively stored washing program can in particular include at least one pre-washing step for pre-cleaning dishes in a pre-wash cycle, at least one cleaning step for thoroughly cleaning dishes in a cleaning cycle, at least one intermediate washing step for removing contaminated washing solution from the dishes in an intermediate washing cycle, at least one rinsing step to avoid spots on the dishes and/or to prepare for a drying step in a rinsing cycle and/or at least one drying step for drying the dishes.

In addition, in particular at least one pre-heating program for controlling a pre-heating cycle for pre-heating washing solution for a washing cycle is stored in the controller. A plurality of pre-heating programs may be provided in which, by way of example, washing solution is pre-heated to different temperatures in each case. The respective pre-heating cycle can be limited to just a pump phase with which the hot water is pumped into the washing solution reservoir if the intake temperature of the hot water is equal to or higher than a desired minimum temperature. Only if the intake temperature of the hot water is lower than this required minimum temperature can a genuine pre-heating phase to re-heat the hot water be simultaneously associated with or precede this pump phase. If re-heating is not required because the incoming hot water already has a sufficiently high actual temperature, which is equal to or greater than a desired minimum temperature, then this hot water is preferably pumped into the reservoir solely with the aid of the connected circulating pump of the inventive dishwasher and when the valve of its washing solution reservoir is open. The heater in the liquid system of the dishwasher, in particular the liquid circulating system of the circulating pump and/or a possibly separately provided washing solution reservoir heater, remains switched off. Once the washing solution reservoir has been filled its valve is closed. The hot water temporarily stored in the washing solution reservoir is ready for calling up for at least a first liquid-conveying partial washing cycle of a dishwashing program that is subsequently started.

A washing solution should in particular be taken to mean a liquid which is provided in order to be applied to the dishes to clean them and/or treat them in some other way. The washing solution can therefore also be provided, by way of example, to heat the dishes, and this is conventional by way of example during a rinsing step. A washing solution is usually made up for the most part of water. Depending on the operating phase of the dishwasher, cleaning agents, cleaning aids such as, by way of example, rinse-aid, other additives and/or dirt which has/have been loosened from the dishes can be added to the washing solution. The washing solution provided for filling the washing solution reservoir is in particular untreated water from an external hot water supply unit. This can in particular be partially or completely heated by a thermal solar system. Obviously other energy sources, and in particular CO₂-reduced or CO₂-neutral or regenerative energy sources, such as pellet or chip heating plants, may be provided for the hot water supply unit.

Once the pre-heating cycle has finished the pre-heated washing solution can be temporarily stored in the dishwasher until the start of a washing cycle and can be used in the context of the washing cycle to treat the dishes, in particular in at least one liquid-conveying partial washing cycle, whereby heating times can be reduced or suppressed during the washing cycle.

Pre-heating program and washing program can advantageously be started independently of each other by a dishwasher user. The user then has the option of initially starting the pre-heating program and of initiating a washing program at any desired later time once the pre-heating program has finished. In this connection the dishes only need to be loaded into the washing chamber of the dishwasher once the pre-heating program has finished. Owing to the shorter heating times the time during which the dishes are not available for their intended use can therefore be reduced in conjunction with the reduction in the running time of the washing program. Of course this does not mean that the dishwasher cannot be at least partially loaded even before the pre-heating program is carried out.

It is of course also possible to call up a washing program if a pre-heating program has not been carried out. However, the running time of the washing program can be lengthened hereby if a comparable cleaning and/or drying effect is to be achieved. However, if this prolongation can be accepted a certain saving in electrical energy may result compared with a “wait & run” operating mode or a quick program because the possible re-heating phase of the pre-heating program in particular is omitted.

In the inventive dishwasher the water required for carrying out washing cycles is expediently admitted via a water inlet device which comprises at least one hot water inlet which can be controlled by the controller. To operate the dishwasher the hot water inlet is connected to an external hot water supply in order to be able to admit hot water. The external hot water supply can, for example, be a conventional domestic hot water supply, and in particular a solar-powered or solar-assisted hot water supply unit which provides, by way of example, hot water with a set point temperature, in particular between 40° C. and 60° C. The hot water inlet is designed in such a way that it can withstand the temperatures that are to be anticipated with a hot water supply over the entire lifetime of the dishwasher.

In the case of the inventive dishwasher it is in particular provided that hot water is admitted during the pre-heating cycle by means of the hot water inlet and the admitted hot water is used in the formation of the washing solution to be pre-heated.

Compared with solutions in which only cold water is admitted during the pre-heating cycle, the energy requirement for pre-heating the washing solution can thus be drastically reduced. If, by way of example, the washing solution is to be heated to a temperature of, for example, 80° C., the electrical energy required for the pre-heating cycle can be reduced in particular by up to 50 percent with admission of hot water, which has a temperature of, for example, 45° C., compared with the admission of cold water.

According to an expedient development of the invention the dishwasher can comprise a cold water inlet which can be controlled by the controller and which is provided for admitting cold water for connection to an external cold water supply. The hot water inlet can comprise a hot water valve and the cold water inlet a cold water valve, it being possible to control the hot water valve and the cold water valve independently of each other by way of the controller. It is hereby possible to admit cold water while the dishwasher is being operated if the use of hot water would not be advantageous or could even be disadvantageous. The load of the external hot water supply in terms of energy can therefore be minimized by the drawing-off of hot water. A resulting temperature can be precisely adjusted to the requirement of a respective operating phase by mixing cold water and hot water. A water inlet device, which in particular comprises a hot water inlet and a cold water inlet, can also be called a bithermic water inlet device.

The controllable hot water valve and/or the controllable cold water valve can preferably be designed as solenoid valves which have only an open state and a closed state. By using valves of this kind it is easily possible to form a washing solution as a function of the respective washing program, which includes hot water from the hot water supply and/or cold water from the cold water supply. It would optionally also be possible, however, to use throttle valves which make it possible to precisely control the flow of hot water or cold water. An external device for controlling water admission can be omitted in both cases.

It may also expediently be provided that the hot water valve is arranged on an upstream end of a hot water hose and is designed in such a way that it can be secured to a connecting piece of the external hot water supply and/or that the cold water valve is arranged on an upstream end of a cold water hose and is designed in such a way that it can be secured to a connecting piece of the external cold water supply. The hot water valve and/or the cold water valve can comprise connecting threads, by way of example, for this purpose which correspond with threads of conventional domestic taps. Valves of this kind can in particular be designed as water stop valves or aquastop valves. A water inlet device, which comprises a hot water inlet fitted with an aquastop valve and a cold water inlet fitted with an aquastop valve, can therefore also be called a bithermic aquastop inlet device.

The expedient arrangement of the hot water valve and/or the cold water valve at the upstream end of the water inlet device has the particular advantage that practically no leakage water can escape from the dishwasher even in the event of damage provided the valves are closed. If the valves are designed in such a way that they close if they are not activated, leakage water is prevented from escaping from a dishwasher that is switched off in practically all cases. To also prevent leakage water from escaping from a dishwasher that is switched on, a leakage water sensor in particular can be associated with the sequential controller to detect leakage water, so the sequential controller can close the valves if leakage water occurs during operation of the dishwasher.

According to an expedient development of the invention the pre-heating cycle can in particular provide pumping of the washing solution into the washing solution reservoir, it being possible to heat the washing solution pumped into the washing solution reservoir during a heating phase using a washing solution reservoir heater associated with the washing solution reservoir. Efficient re-heating of the washing solution is possible as a result since, with an appropriate design of the washing solution reservoir and reservoir heater, only a small quantity of thermal energy is given off to other dishwasher components and/or the environment during the heating phase. It is possible to store the heated washing solution in the washing solution reservoir once the pre-heating cycle has ended, without conveying of the washing solution being necessary for this purpose. Further heat losses can be avoided as a result. Overall the efficiency of the dishwasher can thus be increased.

According to a further advantageous development of the invention the washing solution can be circulated in a circulating system during a heating phase, the circulating system comprising a circulating pump for circulating the washing solution, a heater for heating the circulated washing solution and a spray mechanism for spraying the dishes with the circulated washing solution, the washing solution being conveyed out of a washing chamber in the circulating system and being returned into the washing chamber via the spray system, the washing solution being heated by the heater.

A circulating system of this kind exists in practically every modern dishwasher to be able to apply washing solution to the dishes in the water-conveying partial washing cycles, i.e. in particular during a pre-wash cycle, a cleaning cycle, an intermediate washing cycle and/or during a rinsing cycle, of a washing cycle. The circulating pump, the heater and valves optionally associated with the spray system, water distributors and the like can be controlled by the dishwasher controller. The circulating pump, which is present anyway, can therefore be used during the heating phase to circulate the washing solution, it being possible for the circulated washing solution to be conveyed past the heater, which is also present anyway, and to be heated by it. The spray mechanism, which is present anyway, can then be used to close the circulating system. The invention can consequently be implemented without any change in the construction of a known dishwasher in that a pre-heating program is provided which automatically controls said components during the pre-heating cycle.

By circulating the washing solution during the heating process, the entire volume of washing solution can, moreover, be heated quickly and uniformly.

According to a further advantageous development of the invention a first circulating system can be provided for applying washing solution to dishes that are located in a washing chamber, the first circulating system comprising a circulating pump for circulating the washing solution, a heater for heating the circulated washing solution and a spray mechanism for spaying the dishes with the circulated washing solution, the washing solution being conveyed in the first circulating system from the washing chamber and being returned into the washing chamber via the spray mechanism, a branch point being provided on a pressure side of the circulating pump in the first circulating system, with which branch point flow control means are associated which allow the washing solution to circulate optionally in the first circulating system and/or in a second circulating system, the second circulating system comprising the circulating pump, heater and a washing solution reservoir, the washing solution being conveyed in the second circulating system from the washing chamber and being pumped into the washing solution reservoir via a first opening and being returned into the washing chamber via a second opening in the washing solution reservoir, the washing solution being circulated in the second circulating system and being heated by the heater during the heating phase.

The first circulating system described here basically matches the circulating system described above. However, additional flow control means are provided which allow washing liquid to optionally be conveyed via the second circulating system. Flow control means should be taken to mean those means which can affect the flow of a washing liquid. Electrically operable flow control means in particular are provided which easily allow automatic control of the flow of washing liquid by way of a dishwasher controller.

The flow control means are expediently designed in such a way that in a first operating state the washing solution can circulate at least essentially in the first circulating system. Conventional treatment of dishes, for example of tableware, is thus possible. They are also designed in such a way that in a second operating state the washing solution can circulate at least essentially in the second circulating system. However, further operating states may also be provided in which circulation is not possible or circulation in both circulating systems is possible.

By appropriate control of the flow control means it is consequently possible to return the washing solution conveyed by the circulating pump optionally in the first circulating system via the spray mechanism and/or in the second circulating system via the washing solution reservoir and into the washing tank.

By assuming the second operating state of the flow control means, most of the total volume of washing solution can be situated in the washing solution reservoir itself during circulation in the second circulating system, and this ultimately also means that only a small proportion of the circulated washing solution is situated in the washing chamber and can give off heat there.

If the washing solution is accordingly circulated in the second circulating system and heated in the process the washing tank, the insulation thereof, dishes optionally located in the washing tank and further dishwasher components thermally connected to the washing tank, will therefore heat up less than is the case with conventional heating of a washing solution. A washing solution can therefore be heated with less use of energy. Less steam, moreover, is produced in the washing chamber and this reduces the energy losses further.

The second opening of the washing solution reservoir can also be connected to the washing tank in particular such that the washing solution circulated in the second circulating system covers a shorter distance in the washing tank until it reaches the collecting sump than is the case with a washing liquid circulated in the first circulating system and introduced therewith into the washing tank via the spray system and. The heat dissipation of the washing solution in the washing chamber is reduced further hereby.

The dishwasher proposed according to these advantageous variants allows washing solution to be heated in both the first circulating system and the second circulating system with just one heater. This results in a simpler construction of the inventive dishwasher. The heater can be arranged, by way of example, in the washing tank, the collecting sump, between the collecting sump and the circulating pump or between the circulating pump and the branch point.

Furthermore, only one circulating pump is required for circulating the washing solution in the first circulating system and the second circulating system since the pump may be arranged upstream of the branch point. The construction of the inventive dishwasher is simplified further hereby. The circulating pump can be connected at the input side to a collecting sump, arranged on the washing tank, for collecting washing liquid and preferably be arranged in or on the collecting sump, for which reason it is also called a sump.

According to an advantageous development of the invention a temperature of the washing solution can be monitored during the pre-heating cycle by means of a temperature sensor, connected to the controller, for transmitting measured temperature values, the planned heating phase of the pre-heating cycle being controlled as a function of the measured temperature of the washing solution. As a result it is possible, by way of example, to suppress the heating phase planned per se if the temperature of the admitted hot water is higher than the planned temperature of the washing solution. It may be provided that the temperature of the washing solution is reduced by admitting cold water. The end of the heating phase and/or the heating output may also be controlled by way of monitoring in such a way that the washing solution reaches exactly the planned temperature. A temperature sensor by way of example may be used for monitoring the temperature and this is also used during performance of a washing cycle to measure the temperature of the respectively used washing solution. For this purpose it may be arranged in such a way that it is in thermal contact with a washing solution circulated in the first circulating system and with one circulated in the second circulating system.

According to an advantageous development of the invention the washing solution can be returned to the washing chamber in the second circulating system in such a way that it flows downwards along an inner side of a wall of the washing chamber and in particular along a side wall. This ensures that the washing solution circulated in the second circulating system does not come into contact with dishes that are positioned in racks, or only comes slightly into contact therewith. This applies even if for constructional reasons the washing solution is conveyed into an upper region of the washing chamber. A dissipation of heat from the washing solution to the dishes is avoided in this way, so the efficiency of the dishwasher increases further.

According to an expedient development of the invention the second opening can be connected to the washing chamber via a return line for returning the washing solution. A return line allows the washing solution to be conveyed into the washing chamber, irrespective of the arrangement of the washing solution reservoir, such that it gives off little heat there. The return line can run inside and/or outside of the washing chamber.

According to an advantageous development of the invention, in a lower region of the washing chamber the return line can end in the washing chamber, and in particular in its collecting sump. By way of example, the end of the return line can be provided in the vicinity of the collecting sump. Heat loss in the washing solution in the washing chamber can largely be avoided as a result.

According to an expedient development of the invention the second opening can be designed as an overflow opening. A uniform washing liquid level is ensured in the washing solution reservoir in this way without complex controlling means in the region of the second opening. In particular exactly the volume of washing solution which is supplied to the washing solution reservoir via the first opening leaves the washing solution reservoir per unit of time via the overflow opening. A circulating speed favorable to heating, by way of example in an order of magnitude of 20 to 30 l/min, can therefore be easily adjusted by controlling the rotational speed of the circulating pump. This results in a uniform circulating flow, so the volume of washing solution outside of the washing solution reservoir can be kept low, and this is beneficial to energy efficiency, without there being a risk of the water heater running dry, which could result in damage to it.

According to an advantageous development of the invention the first opening and the second opening are arranged on opposing end regions of the washing solution reservoir. This easily promotes a uniform temperature distribution within the heated washing liquid in that flow-impeded regions are at least reduced in the washing solution reservoir. Damage to the dishwasher due to local temperature peaks in the heated washing solution can be prevented as a result.

According to an expedient development of the invention, flow-conducting elements may be provided in the washing solution reservoir. These can reduce the formation of flow-impeding or flow-reduced zones in the washing solution reservoir still further.

According to an advantageous development of the invention the first opening can be arranged at a lower end of the washing solution reservoir. As a result it is possible to empty the washing solution reservoir via the first opening with the aid of the gravitational force of the washing solution. As a result it is easily possible to convey washing solution stored in the washing solution reservoir back into the first circulating system if, by way of example, the dishes are to be treated by means of the washing solution.

According to an expedient development of the invention the flow control means can in particular include a water distributor which comprises at least one controllable output which is connected to at least one spray element of the spray mechanism and which comprises a further output which is connected to a connecting line leading to the washing solution reservoir. There is a water distributor present in practically all modern dishwashers and it is used in particular to distribute washing liquid supplied by the circulating pump to different spray elements of the dishwasher spray system. The spray system can, by way of example, include an upper rotatable spray arm, a lower rotatable spray arm and a fixed ceiling spray, it being possible for each of these spray elements to be connected to an output of the water distributor. The water distributor can have various operating states in which individual outputs, a plurality of these outputs or all of these outputs are optionally opened or closed. The water distributor is controlled automatically in this case.

As a further output for a connecting line to the washing solution reservoir is accordingly expediently provided, the branch point can be integrated in the water distributor, so the construction of the dishwasher is simple. The water distributor can in particular be designed in such a way that all outputs provided for the spray system can be closed at the same time. It is therefore possible, without great expenditure, to interrupt the first circulating system if the washing liquid is to be conveyed via the second circulating system, for instance to heat the washing liquid, without wishing to treat the dishes at the same time. The output for the connecting line can in particular be designed in such a way that it can be controlled or that it is always open.

According to an advantageous development of the invention the flow control means can in particular include a blocking valve which is arranged in the connecting line. A blocking valve is taken to mean a valve which, in contrast to established water distributors which can only block in one flow direction, can interrupt a flow of liquid in both flow directions. As a result the second circulating system can be opened or interrupted and the filling or emptying of the washing solution reservoir controlled with just one valve.

According to an expedient development of the invention it may be provided that the heater is designed as a flow-through water heater. A flow-through water heater includes a water-conducting element, by way of example a pipe, on which or in which at least one heating element is arranged. A flow-through water heater, also called a continuous flow heater, is distinguished by its small size, by good efficiency and by uniform heating of the circulated washing solution. The continuous flow heater can expediently be integrated in the pump which is used during the heating phase to circulate the washing solution.

According to a particularly advantageous development of the invention insulating means may be provided which outwardly counteract a transfer of heat from inside the reservoir. Such insulating means counteract cooling of the washing solution in the reservoir. This increases the efficiency of the dishwasher, in particular if there is a relatively long period between the pre-heating cycle and the washing cycle.

According to an advantageous development of the invention at least a significant portion of the drawn hot water is stored in the washing solution reservoir without re-heating, or the washing solution heated during a re-heating phase is stored in the washing solution reservoir following the pre-heating cycle, and preferably at least until the start of the washing cycle. Compared with solutions in which the heated water is stored in the dishwasher washing chamber after the pre-heating cycle has finished, with a dishwasher advantageously designed in such a way, both heat losses due to heat conduction and heat losses due to evaporation of washing solution can be reduced. If, namely, the pre-heated washing solution is stored in the washing chamber, it is distributed in a lower region of the washing tank, and this leads to it coming into thermal contact over a large area with the bottom and/or a collecting sump of the washing chamber. Heat is dissipated outside via the bottom or the collecting basin as a result. A significant portion of the washing solution can also evaporate in the washing chamber owing to the relatively large volume thereof, so the remaining washing solution is cooled even more. These drawbacks can be avoided by using a washing solution reservoir of a suitable size. Overall, energy losses between the end of the pre-heating cycle and the beginning of the washing cycle can therefore be reduced. As a result the use of energy for re-heating the stored washing solution before or during the washing cycle can be reduced, and this improves the energy efficiency of the dishwasher. The advantage is all the greater the longer this intermediate phase lasts on the basis of user behavior.

Since according to one advantageous development of the invention the temperature of the stored washing solution can, moreover, be higher in particular at the start of the respective washing program than with cold water filling, an intensive thermal effect is achieved with the washing solution as early as at the start of treatment of the dishes, and this becomes noticeable by way of example during a cleaning cycle of the washing cycle due to greater cleaning performance, and this in turn can allow the washing cycle to be shortened whilst retaining a comparable cleaning effect. Furthermore, the dishes can be heated more quickly, for example during a rinsing cycle, if pre-heated washing solution is used, so the dishes can reach the temperature required for a subsequent drying cycle more quickly. This can reduce the length of the washing cycle as a whole still further.

Storing the pre-heating washing solution, i.e. the drawn hot water, without or with re-heating in the washing solution reservoir means, moreover, that in many cases a relatively large amount of steam can be prevented from escaping from the dishwasher during loading of the washing tank following a pre-heating cycle. In particular enrichment of the ambient air with moisture can be prevented as a result. Furthermore, an undesired effect of steam on the user when loading the dishwasher washing chamber may also be avoided and this increases ease of use.

According to a preferred development of the invention a temperature measuring sequence, connected downstream of the pre-heating cycle, may be provided for measuring the temperature of the washing solution, heated during the pre-heating cycle, by means of a temperature sensor. Cooling of the temporarily stored washing solution between the pre-heating cycle and the start of the washing cycle may be detected in this way. It is consequently possible, by way of example, to adapt the course of the washing cycle to the actual temperature of the washing solution or to re-heat the temporarily stored washing solution in the washing solution reservoir by means of a washing solution reservoir heater that is separately provided therein. During the measurement the washing solution can be circulated in the second circulating system, so the temperature sensor can be arranged at any desired point in the second circulating system. Furthermore, the washing solution is thoroughly mixed hereby, so a significant mean temperature can be recorded.

According to an advantageous development of the invention a re-heating sequence may be provided as a function of the temperature measured during the temperature measuring sequence, in which the washing solution is preferably circulated and heated in the second circulating system. It may thus be ensured that the washing solution has the planned temperature at the start of the washing cycle.

According to a preferred development of the invention a first partial washing cycle of the washing cycle is in particular a cleaning cycle in which heated washing solution is used during the pre-heating cycle and stored washing solution is used thereafter. The running time of the washing cycle may be shortened overall by dispensing with a pre-wash cycle. A sufficient cleaning effect may nevertheless be achieved in many cases due to the direct application of the pre-heated washing solution to the dishes.

According to an advantageous development of the invention a rotational speed of the circulating pump can be lower during circulation of washing solution in the second circulating system, in particular during the heating phase, than during circulation in the first circulating system, in particular than during a partial washing cycle of the washing cycle. Swirling of the washing solution in the washing tank can be reduced in this way, and this leads to lower heat dissipation of the washing solution.

According to an advantageous development of the invention a message can be output after the end of the pre-heating cycle which signals the end of the pre-heating cycle to the user. The user is consequently able to use the washing program as soon as possible.

According to an expedient development of the invention the message can be made via an output device which includes in particular acoustic and/or visual output means. Visual output means can in particular include lamps, light-emitting diodes and alpha-numeric and/or graphic output means. Acoustic output means can comprise, by way of example, buzzers and/or loudspeakers.

The invention also relates to a method for making available washing solution in a washing solution reservoir of the liquid system of a dishwasher, especially a domestic dishwasher, for the washing cycle of a subsequent dishwashing program, which is characterized in that in order to fill the washing solution reservoir with washing solution, hot water is obtained from an external hot water supply via a hot water inlet and is introduced into the liquid system.

An advantageous development of the invention also relates to a method for operating an inventive dishwasher, especially a domestic dishwasher, in which a washing cycle for washing dishes is carried out in a washing chamber and a pre-heating cycle is carried out for pre-heating washing solution for the washing cycle. It is provided in this advantageous method variation that during the pre-heating cycle hot water is admitted from an external hot water supply by means of a hot water inlet, the admitted hot water being used to form the washing solution provided for pre-heating. This advantageous method variation allows efficient operation of a dishwasher, in particular an inventive dishwasher.

Other embodiments and developments of the invention are recited in the subclaims. The advantageous embodiments and developments of the invention described above and/or cited in the subclaims can be used individually but also in any combination with each other in the inventive dishwasher and the inventive method.

The invention, its embodiments and developments as well as their advantages will be described hereinafter with reference to drawings, in which:

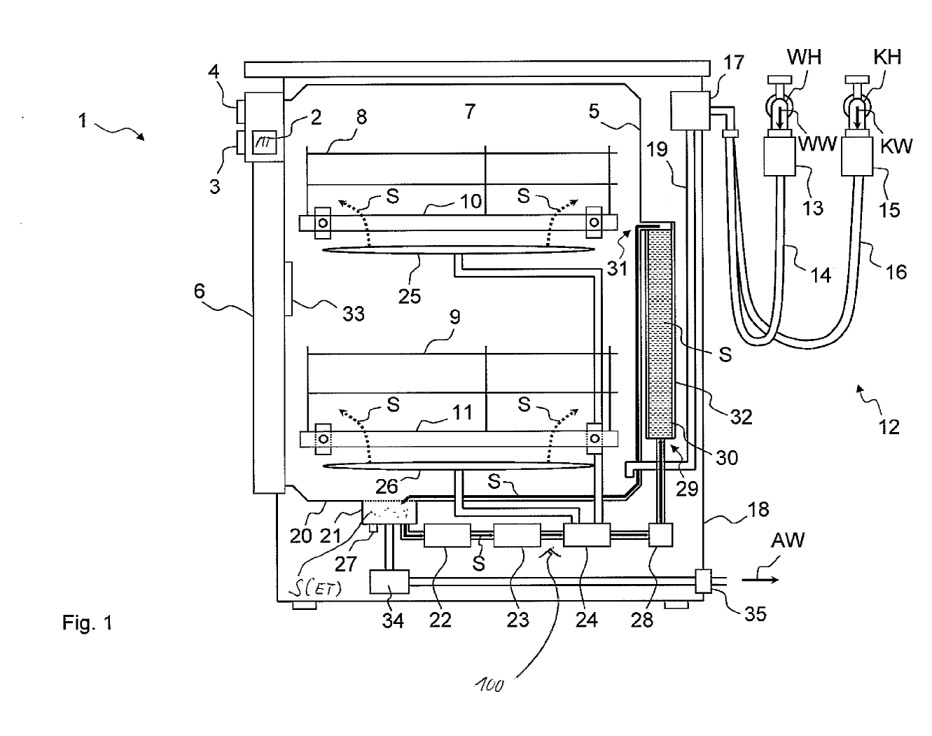

FIG. 1 shows an advantageous exemplary embodiment of an inventive domestic dishwasher in a schematic side view, and

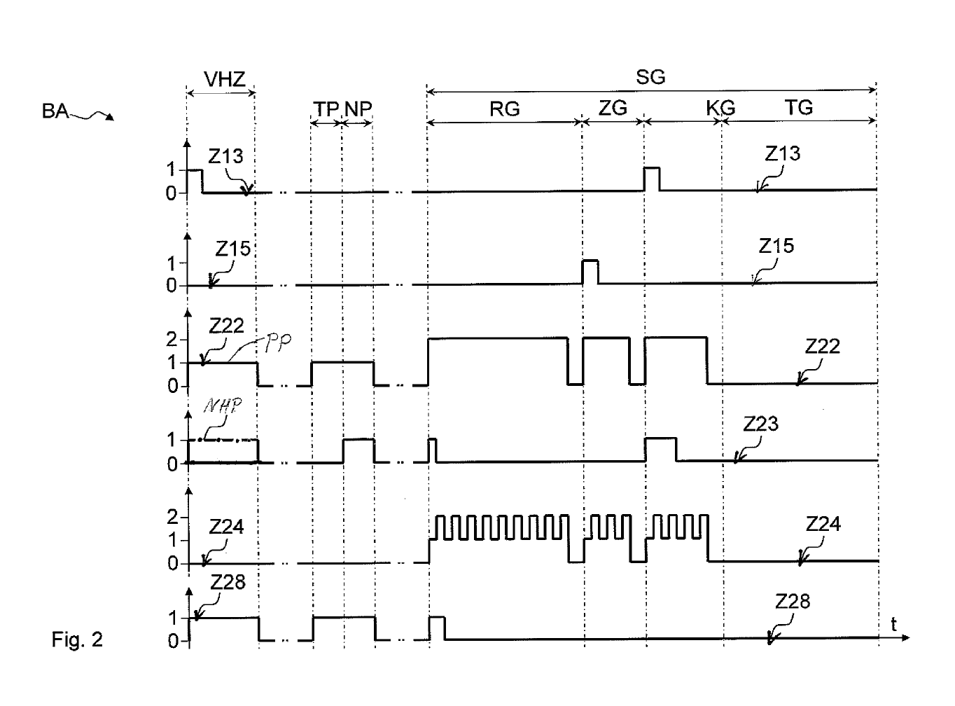

FIG. 2 shows an exemplary operating sequence of the dishwasher of FIG. 1.

In FIG. 1 only those components of a dishwasher which are required for understanding the invention are provided with reference characters and described. It is understood that the inventive dishwasher can comprise additional parts and components.

FIG. 1 shows an advantageous exemplary embodiment of an inventive domestic dishwasher 1 in a schematic side view. The dishwasher 1 comprises a controller 2 in which at least one washing program is stored for controlling a washing cycle for washing dishes, and in particular tableware. A plurality of washing programs is expediently stored, so by choosing a suitable washing program the course of a washing cycle controlled by the controller 2 can be adapted, by way of example, to the size of the load, the type of load, the degree of soiling of the dishes and/or to the desired length of the washing cycle. The washing program(s) can include by way of example at least one pre-washing step, at least one cleaning step, at least one intermediate washing step, at least one rinsing step and/or at least one drying step.

At least one pre-heating program is also stored in the controller 2 for controlling a pre-heating cycle for pre-heating washing solution S for a washing cycle. When carrying out the pre-heating cycle optionally at least some of the washing solution S required for a washing cycle can be heated and, once the pre-heating cycle has finished, can be stored until the washing cycle is carried out. The pre-heating program can be executed before the dishes provided for washing are loaded into the dishwasher 1.

If the dishes are then introduced into the dishwasher 1, pre-heated washing solution is available at the start of performance of the washing cycle, so one or more heating phase(s) for washing solution can be shortened or suppressed during the washing cycle. The washing cycle can consequently be finished much more quickly overall. As a result the period in which the dishes at least remain in the dishwasher 1, and are consequently unavailable for use, is reduced. This advantage is produced in particular if there is a relatively large difference between the temperature of the washing solution planned for the washing cycle and the temperature of the water provided by an external water supply.

A control unit 3 is associated with the controller 2 which allows a user of the dishwasher 1 to call up and consequently start one of the pre-heating programs or one of the washing programs independently of each other. The user therefore has the option firstly of initiating a pre-heating cycle and subsequently a washing cycle. The washing cycle can in principle be started at any desired time once the pre-heating cycle has ended. Since the pre-heating cycle and the washing cycle are consequently not coupled to each other in terms of time, the dishwasher 1 can be used very flexibly in accordance with the user's requirements. Secondly, the user has the option of starting a washing cycle without a preceding pre-heating cycle, and this may be expedient if there is sufficient time for performance of a washing cycle or if performance of a pre-heating cycle planned per se has accidentally failed to occurr.

An output device 4 is also associated with the controller 2 and this allows messages to be output to the user. To output visual messages the output device 4 can in particular include indicator lamps, light-emitting diodes, an alpha-numeric display and/or a graphic display. To output acoustic messages the output device 4 can, moreover, in particular comprise a buzzer, a loudspeaker and/or the like. The end of a pre-heating cycle in particular can be communicated to the user by means of the output device 4.

The dishwasher 1 also comprises a washing tank 5 which can be closed by a door 6, so a closed washing chamber 7 for washing dishes is produced. FIG. 1 shows the door 6 in its closed position. The door 6 can be brought into an open position by swiveling about an axis arranged perpendicularly to the drawing plane. In this open position the door is essentially horizontally oriented and allows the introduction or removal of dishes. In the exemplary embodiment shown in FIG. 1 the control unit 3 is arranged in a user-friendly manner on an upper section of the door 6. The output device 4 is also arranged on the upper section of the door 6, so visual messages are clearly visible and acoustic messages are clearly audible. The controller 2 is also positioned there, so the required signal connection between the control unit 3, the output device 4 and the controller 2 can be kept short. However, in principle it is possible to arrange the control unit 3, the output device 4 and/or the controller 2 at a different location. The controller 2 could also be decentrally designed, which is taken to mean that it includes spaced apart components which are connected via communication means in such a way that they can cooperate.

For accommodating dishes the dishwasher 1 comprises an upper rack 8 and a lower rack 9. The upper rack 8 is arranged on pull-out rails 10 which are each secured to a side wall of the washing tank 5. When the door 6 is open the rack 8 can be pulled out of the washing tank 5 by means of the pull-out rails 10, and this facilitates loading and unloading of the upper rack 8. The lower rack 9 is arranged on pull-out rails 11 in an analogous manner.

The dishwasher 1 also comprises a schematically illustrated water inlet device 12. This comprises a hot water inlet 13, 14 and a cold water inlet 15, 16, the hot water inlet 13, 14 being provided for admitting hot water WW from an external hot water supply WH and the cold water inlet 15, 16 being provided for admitting cold water KW from an external cold water supply KH. A water inlet device 12 of this kind is also called a bithermic water inlet device 12.

The hot water inlet 13, 14 comprises a hot water valve 13 and the cold water inlet 15, 16 comprises a cold water valve 15. The hot water valve 13 and the cold water valve 15 can be controlled by the controller 2 and in principle are identical. The two valves 13, 15 can, by way of example, be designed as solenoid valves. The input sides of the valves 13, 15 are each designed in such a way that they may be secured to connecting pieces WH, KH of a conventional domestic water supply, for example to taps WH, KH. The connection can be made by means of a screw connection, a snap connection or the like in each case. Valves 13, 15 of this kind can in particular be designed as aquastop valves 13, 15. The bithermic water inlet device 12 can therefore also be called a bithermic aquastop device 12.

The valves 13, 15 are advantageously closed if they are not activated, so the dishwasher 1 is disconnected from the water supply WH, WK when it is switched off. Leakage water can thus be prevented from escaping from the switched-off dishwasher 1 in the event of a fault.

As intended the input side of the hot water valve 13 is connected in FIG. 1 to a hot water tap WH and the input side of the cold water valve 15 is connected to a cold water tap KH. The output side of the hot water valve 13 is connected to a hot water hose 14 and the output side of the cold water valve 15 is connected to a cold water hose 16, the downstream ends of the hot water hose 14 and the cold water hose 16 being connected to an input side of a connecting piece 17 on a housing 18 of the dishwasher 1. By means of the water inlet device 12 it is consequently possible to conduct hot water WW from an external hot water supply WH and/or cold water KW from an external cold water supply KH, individually controlled in each case, into the interior of the dishwasher 1. The hot water supply can in particular be fed with thermal energy in part or entirely by a thermal solar system.

The hot water hose 14 and/or the cold water hose 16 can be designed as safety hoses with an inner water-conveying pressure hose and an outer covering hose, it being possible to provide a respective leakage water channel for discharging possible leakage water between pressure hose and covering hose. Leakage water, which occurs during operation of the dishwasher 1 in the region of the water inlet device 12, can be conveyed via the connecting piece 17, secured to the housing, into the interior of the dishwasher 1. Here it can be detected by a leakage water sensor (not shown), so appropriate measures, for instance closing of the hot water valve 13 and cold water valve 15, can be initiated.

The dishwasher 1 also comprises liquid-conveying connecting means 19 which allow the admitted water WW, KW to be conveyed from the output of the connecting piece 17, secured to the housing, into the washing chamber 7. It may be provided in this connection that a water preparation device (not shown) for preparing the admitted water WW, KW and/or a heat exchanger for pre-heating the admitted water WW, KW is guided in the liquid-conveying connecting means 19 before it passes into the washing chamber 17.

A collecting sump 21 is formed on a bottom 20 of the washing tank 5 in which washing solution S situated in the washing chamber 7 collects as a result of its gravitational force. The collecting sump 21 is connected to a circulating pump 22 with the aid of which washing solution S can be pumped from the collecting sump 21 via a heater 23 to a water distributor 24.

The circulating pump 22, heater 23 and water distributor 24 are controlled by the controller 2 during operation of the dishwasher 1.

The circulating pump 22 preferably comprises a brushless electric motor, preferably a brushless permanent magnet motor, which can be designed as a d.c. motor, an a.c. motor or a synchronous motor. The rotor of a brushless permanent magnet motor comprises at least one permanent magnet whereas the stator comprises a plurality of electromagnets. These electromagnets are commutated via an electronic control device. The direction of rotation of the permanent magnet rotor can be unambiguously fixed via the electronic control device, so the water-conveying parts of the circulating pump 22 can be fluidically optimized with respect to a planned direction of rotation. This results in a high output with low use of energy. Furthermore, the rotational speed of the motor, and therewith the output of the circulating pump 22, can be controlled as required by means of the electronic control device. The brushless permanent magnet can also be designed as a glandless pump so that expensive sealing measures can be dispensed with.

The heater 23 is provided for heating washing solution S and is designed as a continuous flow heater 23. Alternatively or in addition an openly arranged heating element could also be provided, by way of example a heating element arranged in the washing chamber 7 or in the collecting sump 21.

The water distributor 24 allows controlled onward conveying of the washing solution S supplied by the circulating pump 22. In the exemplary embodiment it comprises three outputs, of which a first one is connected to an upper rotatable spray arm 25 and a second one is connected to a lower rotatable spray arm 26. The spray arms 25 and 26 form a spray mechanism 25, 26 arranged in the washing chamber 7 which allows washing solution S to be applied to dishes. The water distributor 24 can be controlled in such a way that the washing solution S conveyed by the circulating pump 22 is optionally conveyed through none of the spray arms 25, 26, through one of the spray arms 25, 26 or through both spray arms 25, 26 and into the washing chamber 7.

With appropriate control of the water distributor 24 a first circulating system is thus formed in which washing solution S is taken from the collecting sump 21 of the washing chamber 7 and can be returned via the circulating pump 22, heater 23, water distributor 24 and the spray system 25, 26 into the collecting sump 21. The first circulating system is used in particular to apply washing solution S, issuing from the spray arms 25, 26 and which is shown in FIG. 1 by dotted arrows, to the dishes. The circulated washing solution S can simultaneously be heated by means of the heater 23, it being possible to monitor the temperature of the washing solution S by means of a temperature sensor 27. The temperature sensor is connected to the controller 2 for transmitting measured temperature values. The heater 23 can be controlled as required and automatically as a result. In particular the temperature of the washing solution S can be brought to the required temperature and optionally kept at this temperature during a partial washing cycle of a washing cycle in which washing solution S is applied to the dishes.

A further output of the water distributor 24 is connected to a blocking valve 28 which can be controlled by the controller 2 and is for its part connected to a first opening 29 of a washing solution reservoir 30. However, further outputs could also be provided on the water distributor 24, by way of example to allow charging of additional spray arms or fixed spray elements.

The output of the water distributor 24 connected to the blocking valve 28 can always be open. The washing solution reservoir 30 can therefore be charged with washing solution S by means of the circulating pump 22 when the blocking valve 28 is open. The washing solution S in the washing solution reservoir 30 can then be stored in the washing solution reservoir 30 by closing the blocking valve 28, and be discharged from the washing solution reservoir 30 via the first opening 29 under the effect of gravity by re-opening the blocking valve 28, since the first opening 29 is arranged in a bottom region of the washing solution reservoir 30.

At an upper end the washing solution reservoir comprises a second opening 31 which is designed as an overflow opening 31. If, therefore, more washing solution S is pumped into the washing solution reservoir 30 than it can hold, the washing solution S runs through the overflow opening 31 and out of the washing solution reservoir 30. The overflow opening 31 is fluidically connected to the washing chamber 7, so overflowing washing solution S passes into the washing chamber 7 and there flows into the collecting sump 21.

If, therefore, the blocking valve 28 is open, washing solution S can be circulated in a second circulating system in which washing solution S is taken from the collecting sump 21 and can be returned via the circulating pump 22, heater 23, water distributor 24, blocking valve 28 and washing solution reservoir 30 into the collecting sump 21. To circulate the washing solution S solely in the second circulating system the water distributor 24 can be controlled in such a way that its outputs connected to the spray system 25, 26 are closed. Washing solution S, which is circulated in the second circulating system, is illustrated in FIG. 1 by solid-line arrows.

The second circulating system can in particular allow washing solution S to circulate without washing solution S being applied to dishes. Furthermore, the circulated washing solution comes into contact with only a small region of the washing tank 5. As a result a washing solution S circulated in the second circulating system can be heated by means of the heater 23 without significant heat losses, and this is particularly advantageous during a pre-heating cycle since only heating of the washing solution S, but not the application of washing solution S to dishes, is usually desired in this case. Furthermore, less steam is therefore produced in the washing chamber, and this also leads to lower energy losses. However, less steam is also advantageous if the door 6 is opened after the pre-heating cycle to load dishes into the washing chamber 7 for the first time, or to add some, since then the room climate is less affected by escaping steam.

In the exemplary embodiment of FIG. 1 the washing solution S circulated in the second circulating system passes along an inner wall of the washing tank 5 and along the bottom 20 of the washing tank 5 from the overflow opening 31 back into the collecting sump 21. However, exemplary embodiments are also conceivable in which the overflow opening 31 is connected by return means to the washing chamber 7, and these may be designed as pipes, hoses and the like. The end of such return means can be arranged in the vicinity of the collecting sump 21 or in the collecting sump 21, so the heat dissipation of the washing solution S to the washing chamber 7 and/or the formation of steam can be reduced further.

The washing solution reservoir 30 can be provided with layered thermal insulating means 32 at an essential part of its surface, so washing solution S situated in the washing solution reservoir 30 at best dissipates little heat.

The dishwasher 1 can also comprise a metering device 33 which is arranged by way of example on the inside of the door 6. The metering device 33 is controlled by the controller 2 and allows cleaning agent and/or cleaning aids, such as rinse aid, to be added to the washing solution S during a washing cycle. A drain pump 34 may also be provided with which washing solution S that is no longer required can be pumped out as waste water AW via a waste water connection 35. The waste water connection 35 can be connected to an external waste water disposal plant by a waste water hose (not shown).

The function of the dishwasher 1 is accordingly as follows: if the user activates a pre-heating program to control a pre-heating cycle, firstly a planned volume of hot water WW is introduced into the liquid system 100 of the dishwasher 1, and in particular into its washing chamber 7, by means of the hot water inlet 13, 14. Here the hot water WW thus introduced forms a washing solution S. Owing to its gravitational force this washing solution S collects in the collecting sump 21 of the liquid system 100. In a pump phase PP (see FIG. 2) that now follows the circulating pump 22 of the liquid system is switched on, so washing solution is pumped out of the collecting sump 21 to the heater 23. The heater 23 can optionally be switched on at least temporarily, so the circulated washing solution S is re-heated in an optional re-heating phase NHP (shown in dashed lines in FIG. 2), if this is required, in order to reach the desired set point temperature MT. In other words, the actual temperature ET of the incoming hot water WH can already be equal to or greater than the desired set point temperature MT. Re-heating by means of the heater 23 is then unnecessary and this can remain switched off or be switched off. The water distributor 24 connected to the output of the heater 23 is controlled during a possibly required heating phase NHP in such a way that the conveyed washing solution S cannot pass to the spray system 25, 26. Instead the washing solution S passes through the open blocking valve 28 to the first opening 29 of the washing solution reservoir 30 and enters therein by way of the pumping procedure of the switched-on circulating pump 22. The washing solution reservoir 30 will be completely filled with incoming hot water WW by means of the circulating pump 22 in particular if a re-heating procedure or a re-heating phase NHP occurs, so the excess washing solution S runs via the second opening 31 of the washing solution reservoir back into the collecting sump 21. The washing solution is thereby circulated in the second circulating system during the possibly required re-heating phase. If the washing solution S has a planned minimum temperature or set point temperature MT as early as from the start due to the incoming hot water, or has reached it during a possible re-heating procedure NHP, and this can be checked by means of the temperature sensor 27, the circulating pump 22 and the heater 23 are switched off and the blocking valve 28 closed. Heating phase NHP and pre-heating cycle VHZ as a whole are ended therewith. In particular if the incoming hot water already has an incoming temperature ET which is equal to or greater than the required minimum temperature MT it can be sufficient to pump this hot water WW into the washing solution reservoir 33 by means of the circulating pump 22 until this has been filled with a desired volume of water or in particular until this is full. The inlet valve 28 is then closed and the circulating pump switched off.

If, therefore, no re-heating is required, because the incoming hot water already has an adequately high actual temperature ET, which is greater than a desired minimum temperature MT, this hot water WW is merely pumped with the aid of the switched-on circulating pump 22 and with open valve 28 into the washing solution reservoir 30. The heater 23 remains switched off in the process. Once the washing solution reservoir 30 has been filled, valve 28 is closed. The hot water temporarily stored in the washing solution reservoir is ready for retrieval.

The door 6 can now be opened to introduce dishes into the washing chamber 7 for the first time or to load more dishes. When the washing chamber 7 is loaded as intended the user can call up a washing program to control a washing cycle. The washing program can now be carried out using washing solution S situated in the washing solution reservoir 30, so heating phases during the washing cycle may be shorter than with conventional dishwashers, or can be omitted altogether.

During the washing cycle the dishes can be treated with washing solution S in that washing solution S, which is firstly taken from the washing solution reservoir 30 via the blocking valve 28, is conveyed by means of the circulating pump 22 via the heater 23 and water distributor 24 to the spray arms 25 and 26. The heater 23 can optionally be used for re-heating the washing solution S if required. The water distributor 24 can be controlled in such a way that the spray arms 25 and 26 are supplied with washing solution S alternately or at the same time. During the washing cycle the circulating pump 22 is usually operated at its normal rotation speed, so the washing solution S issuing from the spray arms 25 and 26 is sprayed against the dishes from below. The egress of the washing solution S during the washing cycle is shown in FIG. 1 by dotted arrows.

FIG. 2 shows the sequence of an exemplary operating procedure BA of an inventive dishwasher 1, a pre-heating cycle VHZ and a washing cycle SG being shown. On a common time axis t a curve Z13 shows the operating state of the hot water valve 13 of the hot water inlet 13, 14, a curve Z15 shows the operating state of a cold water valve 15 of the cold water inlet 15, 16, a curve Z22 shows the operating state of the circulating pump 22, a curve Z23 shows the operating state of the heater 23, a curve Z24 shows the operating state of the water distributor 24 and a curve Z28 shows the operating state of the blocking valve 28.

At the start of the pre-heating cycle VHZ a filling phase is carried out whose purpose it is to form a planned volume of washing solution S in the washing chamber 7 of the dishwasher 1. For this purpose the hot water valve 13 can be brought into an operating state “1” in which there is an intake of hot water WW. At the start of the pre-heating cycle the circulating pump 22 is, moreover, switched on with a low rotational speed and the blocking valve 28 is opened, and this is also denoted as operating state “1” in FIG. 2 respectively. The heater 23 is firstly switched off, and this is shown in FIG. 2 as operating state “0”. Both outputs of the water distributor 24 are closed. This operating state of the water distributor is denoted by “0” in FIG. 2.

The washing solution S is circulated in the second circulating system due to said operating states of the circulating pump 22, water distributor 24 and blocking valve 28. The intake temperature ET of the solution is measured by means of the sensor 27 in the collecting basin 21. If the measured temperature ET is below a planned set point temperature MT a re-heating phase NHP is begun in that the heater 23 is switched on, and this is shown in FIG. 2 by dot-dash lines by the operating state “1”. If, on the other hand, the temperature of the washing solution S is greater than the planned set point temperature MT, the heating phase NHP is not carried out. The heater 23 then remains switched off. Instead the temperature could optionally be reduced by opening the cold water valve 15 to admit cold water. When a planned volume of hot water WW (and/or cold water KW) has been introduced into the washing chamber 7 the hot water valve 13 (and/or the cold water valve 15) is closed again, and this is shown in FIG. 2 as operating state “0”.

In the exemplary embodiment of FIG. 2 the heating phase HP is carried out until the washing solution S is heated to the required temperature MT. At this instant the circulating pump 22 and the heater 23 are switched off and the blocking valve 28 closed. The pre-heating cycle VHZ is thus ended.

Once the pre-heating cycle VHZ has ended a message is output which signals the end of the pre-heating cycle VHZ to the user. As a result the user is able to use the now possible washing cycle as soon as possible. The message can be output via the output device 4 which for this purpose can include acoustic and/or visual output means.

During the rest phase that now follows a temperature test sequence TP may be carried out to be able to detect a reduction in the temperature of the washing solution S. The temperature test sequence TP can, by way of example, automatically be carried out after a predefined time has elapsed and optionally several times. For this purpose the circulating pump 22 is again operated at a low rotational speed and the blocking valve 28 opened, so the washing solution S is circulated in the first circulating system. As a result the washing solution S is guided along the temperature sensor 27 so the latter can record a mean temperature of the washing solution S. Since the washing solution S is not conveyed via the spray system 25, 26 the washing liquid S cools only slightly during the temperature test sequence TP.

Once the temperature of the washing solution S has been measured a re-heating phase can be carried out if the temperature has fallen below a predefined limit value by way of example. For this purpose the dishwasher 1 is operated as in the heating phase HP of the pre-heating cycle.

The dishwasher 1 accordingly remains in a rest state until the user starts a washing cycle SG by calling up a washing program, or another temperature measuring sequence TP is carried out. In the example of FIG. 2 the washing cycle SG accordingly carried out includes in particular, in this sequence, a cleaning cycle RG, an intermediate washing cycle ZG, a rinsing cycle KG and a drying cycle TG. It is understood that the washing cycle SG could also include other partial washing cycles. In particular, however, a pre-washing cycle may be omitted if a reduction in the program running time is advantageously desired because there is now a pre-heated volume of water available from the washing solution reservoir as early as at the start of the cleaning cycle RG.

The blocking valve 28 is opened at the start of the cleaning cycle RG to allow the pre-heated washing solution S to pass into the washing chamber 7. Curve Z28 symbolizes this operating state by short-term adoption of the value “1”. The circulating pump 22 is also switched on at the start of the cleaning cycle RG and operated at high rotational speed, and this is shown by operating state “2”. If required the heater 23 may also be switched on for a short time if the temperature of the washing solution S should not be adequate. The water distributor 24 is controlled in such a way that the lower spray arm 26 and the upper spray arm 25 are alternately loaded with washing liquid S. Curve Z24 shows this by alternate assumption of the values “1” or “2”. In an end phase of the cleaning cycle RG the circulating pump 22 is switched off and the washing liquid S of the cleaning cycle RG is pumped away via a waste water connection with the aid of the drain pump 34.

The intermediate washing cycle ZG that now follows is essentially used to completely remove the washing solution S of the cleaning cycle RG from the dishes. Cold water can be used for this purpose without any significant drawbacks. The cold water valve 15 is therefore opened at the start of the intermediate washing cycle ZG to introduce cold water KW into the washing chamber 7. The circulating pump 22 is also switched on again and operated at a high rotational speed. The heater 23 is usually not switched on during the intermediate washing cycle ZG. The water distributor 24 is also controlled during the rinsing cycle KG in such a way that the spray arms 25 and 26 are alternately provided with washing liquid S. At the end of the intermediate washing cycle ZG the washing liquid S of the intermediate washing cycle ZG can also be pumped out by means of the drain pump 34.

At the start of the rinsing cycle KG the hot water valve 13 is opened again to introduce hot water WW into the washing chamber 7. The circulating pump 22 is also switched on again and operated at a high rotational speed. Since a higher temperature is usually required for the washing liquid during the rinsing cycle KG than during a cleaning cycle RG, the heater 23 is usually switched on again for a certain time. The required heating time can nevertheless be kept short by the use of hot water WW. Potentially no re-heating by means of the heater 23 is required with a sufficiently high temperature of the incoming hot water, i.e. the incoming hot water with its incoming temperature is then sufficient per se. The water distributor 24 is also controlled during the rinsing cycle KG in such a way that the spray arms 25 and 26 are alternately supplied with washing liquid S. At the end of the rinsing cycle KG the washing liquid S of the rinsing cycle KG can be pumped out by means of the drain pump 34.

The dishes are subsequently dried in the drying cycle TG by way of example by what is known as self-drying in which the residual water adhering to the dishes evaporates and condenses by way of example on the washing tank 5, or by a drying device which is not described within the scope of this application.

Overall the length of the washing cycle SG is shortened since pre-heated washing solution S is available in the washing solution reservoir 30 at least for the cleaning cycle RG, owing to the pre-heating cycle VHZ, carried out in advance, with or without re-heating phase NHP. Hot water WW can be admitted from an external hot water supply WH for additional partial washing cycles, by way of example for the rinsing cycle KG. As a result the heating times during both the cleaning cycle RG and the rinsing cycle KG can be kept short. Furthermore, the use of hot water WW from an external hot water supply WH during the pre-heating cycle VHZ and/or during the washing cycle SG means that the energy efficiency of the dishwasher 1 can be improved.

In an advantageous exemplary embodiment an inventive dishwasher comprises a washing solution reservoir and a bithermic aquastop. A pre-heating cycle can be started in particular via a standby switch. During the pre-heating cycle the appliance is filled with hot water and if required the water is optionally heated further, for example to 80° C. If the intake temperature is too high heating can be omitted, however, and/or cold water can be added. The dishwasher communicates its readiness once the pre-heating cycle has finished, and waits. The customer can fill the appliance with dishes to be cleaned and start a washing cycle. The stored hot water can be used in the first liquid-conveying partial washing cycle of the washing cycle. Hot water and/or cold water can be added in further partial washing cycles. A simple and inexpensive solution for pre-heating the dishwasher without additional effort is therefore made available. Preparing the dishwasher with a hot water intake of at least one additional washing solution reservoir for at least one partial bath volume or the total bath volume of a subsequent washing step, such as a cleaning step of a subsequently started dishwashing program, is in particular called “wait & run”.

Since the washing solution reservoir is filled with hot water from the external hot water supply, additional heating of this temporarily stored washing liquid can in particular be dispensed with or at least be less than would be required with incoming cold water from a cold water connection. This means that the pre-heating cycle can be limited solely to a pump phase. Only if the intake temperature of the incoming hot water, which is provided for temporary storage in the washing solution reservoir, is not sufficient, i.e. is lower than a desired set point temperature, can this temporarily stored liquid be re-heated in various ways—in particular as described in relation to the advantageous exemplary embodiments of FIGS. 1 and 2. Energy can therefore be saved by the use of hot water for filling of the washing solution reservoir. This applies in particular if the hot water has been produced in the external hot water supply using a regenerative or ecologically sound energy source, such as a thermal solar system.

### LIST OF REFERENCE CHARACTERS

1 dishwasher
2 controller
3 control unit
4 output device
5 washing tank
6 door
7 washing chamber
8 upper rack
9 lower rack
10 pull-out rail
11 pull-out rail
12 water inlet device
13 hot water valve
14 hot water hose
15 cold water valve
16 cold water hose
17 connecting piece secured to housing
18 housing
19 connecting means
20 bottom of the washing tank
21 collecting sump
22 circulating pump
23 heater
24 water distributor
25 upper spray arm
26 lower spray arm
27 temperature sensor
28 blocking valve
29 first opening, filling and discharge opening, input opening
30 washing solution reservoir
31 second opening, overflow opening, output opening
32 insulating means
33 metering device
34 drain pump
35 waste water connection
100 liquid system
WH hot water supply, hot water tap
KH cold water supply, cold water tap
WW hot water
KW cold water
S washing solution
AW waste water
BA operating procedure
VHZ pre-heating cycle
PP pump phase
MT intake temperature
ST minimum or set point temperature
TP temperature measuring sequence
NHP re-heating phase
SG washing cycle
RG cleaning cycle
ZG intermediate washing cycle
KG rinsing cycle
TG drying cycle
Z13 operating state of the hot water valve
Z15 operating state of the cold water valve
Z22 operating state of the circulating pump
Z23 operating state of the heater
Z24 operating state of the water distributor
Z28 operating state of the blocking valve

1-9. (canceled)

10. A dishwasher, comprising:
a liquid system having a washing solution reservoir for making available washing solution for a washing cycle of a subsequent dishwashing program; and
an external hot water supply having a hot water inlet via which hot water is introducible into the liquid system for forming the washing solution and filling the washing solution reservoir with washing solution.

11. The dishwasher of claim 10, constructed in the form of a domestic dishwasher.

12. The dishwasher of claim 10, wherein the external hot water supply is in fluid communication with the washing solution reservoir to introduce hot water without re-heating when the hot water has an intake temperature which is equal to or greater than a minimum temperature.

13. The dishwasher of claim 10, further comprising a heater for re-heating hot water before being introduced into the washing solution reservoir, or hot water introduced into the washing solution reservoir, to at least a desired minimum temperature when the hot water has an intake temperature which is less than a minimum temperature.

14. The dishwasher of claim 10, further comprising a controller controlling operation of the hot water inlet to control a flow of hot water from the external hot water supply.

15. The dishwasher of claim 10, further comprising an external cold water supply having a cold water inlet via which cold water is introducible into the liquid system, and a controller controlling operation of the cold water inlet to control a flow of cold water from the external cold water supply into the liquid system.

16. The dishwasher of claim 10, further comprising a controller configured for calling up a at least one washing program for controlling a washing cycle for washing dishes in a washing chamber and at least one preceding pre-heating program for controlling a pre-heating cycle for the washing solution to be temporarily stored in the washing solution reservoir.

17. The dishwasher of claim 16, wherein the controller is configured to execute the washing program and the pre-heating program separately from each other.

18. The dishwasher of claim 16, wherein the controller is configured to execute the pre-heating cycle only during a pump phase in which hot water is pumped from the external hot water supply into the washing solution reservoir.

19. The dishwasher of claim 16, further comprising a heater for re-heating hot water during a re-heating phase of the pre-heating cycle.

20. A method for making available washing solution in a washing solution reservoir of a liquid system of a dishwasher for a washing cycle of a subsequent dishwashing program, said method comprising:
obtaining hot water from an external hot water supply via a hot water inlet for use as a washing solution; and
introducing hot water into the liquid system to fill the washing solution reservoir with washing solution.

21. The method of claim 20 for operation of a domestic dishwasher.

22. The method of claim 20, wherein the hot water is introduced into the washing solution reservoir without re-heating when the hot water has an intake temperature which is equal to or greater than a minimum temperature.

23. The method of claim 20, further comprising re-heating hot water before being introduced into the washing solution reservoir or hot water introduced into the washing solution reservoir to at least a desired minimum temperature when the hot water has an intake temperature which is less than a minimum temperature.

24. The method of claim 20, further comprising controlling operation of the hot water inlet to control a flow of hot water from the external hot water supply.

25. The method of claim 20, further comprising controlling operation of a cold water inlet to control a flow of cold water from an external cold water supply into the liquid system.

26. The method of claim 20, further comprising controlling in at least one washing program a washing cycle for washing dishes in a washing chamber, and controlling in at least one preceding pre-heating program a pre-heating cycle for the washing solution to be temporarily stored in the washing solution reservoir.

27. The method of claim 26, wherein the washing program and the pre-heating program are executed separately from each other.

28. The method of claim 20, wherein the pre-heating cycle is executed only during a pump phase in which hot water is pumped from the external hot water supply into the washing solution reservoir.

29. The method of claim 26, further comprising re-heating hot water during a re-heating phase of the pre-heating cycle.
